(19) United States
(12) Patent Application Publication
(10) Pub. No.: US 2013/0327912 A1
(43) Pub. Date: Dec. 12, 2013

(54) DEVICE MOUNTING APPARATUS

(71) Applicant: Yamaha Corporation, Hamamatsu-Shi (JP)

(72) Inventors: Masao YOSHIDA, Hamamatsu-Shi (JP); Kazuya ATSUMI, Hamamatsu-Shi (JP)

(21) Appl. No.: 13/916,438

(22) Filed: Jun. 12, 2013

(30) Foreign Application Priority Data
Jun. 12, 2012 (JP) 2012-132775

(51) Int. Cl. F16M 13/02

(52) U.S. Cl. CPC F16M 13/022
USPC 248/289.11; 248/288.11

(57) ABSTRACT

A speaker mounting apparatus for mounting a mounting part includes: a support member to be fixed to the speaker unit; a fixing plate to be fixed to the mounting part; and a positioning mechanism including an externally toothed engagement member provided on the support member and an internally toothed engagement member provided on the fixing plate. The externally toothed engagement member is brought into the internally toothed engagement member by the dead weight of the support member or the speaker unit fixed to the support member. Thus, movement of the support member relative to the fixing plate is prevented so that the support member is positioned in a peripheral direction (rotational direction) relative to the fixing plate.

### BACKGROUND

The present invention relates to device mounting apparatus for mounting a device, such as a speaker unit, to a mounting surface of a wall section, pillar or the like.

Among examples of the conventionally-known device mounting apparatus for mounting various pieces of equipment or devices, such as speaker units and illuminating devices, to mounting surfaces like ceilings, side walls and pillars of rooms is a speaker device mounting apparatus disclosed in Japanese Patent Application Laid-open Publication No. 2001-317508 (hereinafter referred to as “the relevant patent literature”). The speaker device mounting apparatus disclosed in the relevant patent literature is capable of adjusting vertical and horizontal orientations (mounted angles) of a speaker unit when the speaker unit is to be mounted to a wall, pillar or the like.

According to the disclosure of the relevant patent literature, the speaker unit is fixed to a speaker-side mounting member in advance, but also a fixing member having a bar-shaped section is fixed to a ceiling in advance. Then, the speaker-side mounting member is passed over the bar-shaped section of the fixing member fixed to the ceiling, moved to a desired position on the bar-shaped section, and then pivoted, at that desired position, in its peripheral direction about the bar-shaped section so that the speaker-side mounting member is set at a desired rotational angle or orientation. Then, in that state, the speaker-side mounting member is fastened or fixed at the desired position and at the desired rotational orientation by a human operator turning a knob portion of a fastening screw of the mounting member.

However, with the speaker device mounting apparatus disclosed in the relevant patent literature, the position and angle (orientation) of the speaker-side mounting member relative to the bar-shaped section is not determined until the knob portion of the fastening screw is fully tightened. Thus, the speaker unit and the mounting member have to be kept supported with a hand until the knob portion of the fastening screw is fully tightened. Namely, with the speaker-side mounting member set at the desired position and at the desired rotational orientation, the human operator has to tighten the knob portion of the fastening screw with one hand while supporting the speaker unit with the other hand. Because such an operation is performed at a high position above the human operator's head near the ceiling of the room, it tends to become a very difficult operation. Further, even after the speaker unit has been fixed to the speaker-side mounting member, there may sometimes arise a need to adjust the position and/or orientation of the speaker unit. In such a case too, the human operator has to loosen and tighten the knob portion with one hand while supporting the speaker unit with the other hand. Further, in case the human operator accidentally releases the hand, supporting the speaker unit, form the speaker unit during the aforementioned operation, the speaker unit may fall. Therefore, the speaker unit mounting operation using the speaker device mounting apparatus disclosed in the relevant patent literature tends to be risky and troublesome for a single human operator to perform.

Namely, with the conventionally-known speaker device mounting apparatus, the human operator has to perform positioning of the speaker unit when the speaker unit is to be mounted to a wall or ceiling, or when the speaker unit is to be adjusted in angle after the mounting, simultaneously with another operation, such as fastening by a screw or other fastener, while supporting the speaker unit with one hand. Therefore, the human operator cannot easily mount the speaker unit to a mounting surface with the speaker unit positioned at a desired position and at a desired orientation. Besides, it is difficult to secure safety during the speaker unit mounting operation.

### SUMMARY OF THE INVENTION

In view of the foregoing prior art problems, it is an object of the present invention to provide an improved device mounting apparatus which, when a device, such as a speaker, is to be mounted to a mounting surface of a ceiling, side wall or the like, or after the mounting, allows the device to be accurately positioned at a desired position and orientation with ease and in safety.

Note that the same reference numerals and characters as used for various constituent elements of a later-described embodiment of the present invention are indicated in parentheses in the summary below for ease of understanding.

In order to accomplish the above-mentioned object, the present invention provides an improved device mounting apparatus (1) for mounting a device (60) to a mounting par, which comprises: a first member (10) adapted to be fixed to the device (60); a second member (30) adapted to be fixed to the mounting part; and a positioning mechanism (40) including an engaging section (18) provided on the first member and an engaged section (38) provided on the second member and engageable with the engaging section, the positioning mechanism (40) being constructed in such a manner that the engaging section (18) is brought into engagement with the engaged section (38) by dead weights of the first member and the device. By the engaging section (18) engaging with the engaged section (38), movement of the first member relative to the second member is prevented so that the first member is positioned relative to the second member.

By the provision of the positioning mechanism where the engaging section is brought into meshing engagement with the engaged section by the dead weights of the first member and the device, the present invention allows a human operator to appropriately position the first member relative to the second member, because relative movement of the first member relative to the second movement is prevented when the engaging section is in the engagement with the engaged section in the positioning mechanism. Thus, in positioning the device, the human operator can readily perform the speaker unit positioning operation with a high accuracy and in safety by merely engaging the engaging section with the engaged section external using the dead weight of the device. As a result, the human operator can perform, with ease and in safety, the speaker unit positioning operation when the speaker unit is to be mounted to the mounting part (mounting surface), such as a ceiling or side wall, or positioning adjustment operation after the mounting to the mounting part.

Preferably, the device mounting apparatus may further comprises a rotation mechanism (50) for rotatably supporting the first member (10) relative to the second member (30), and the positioning mechanism (40) is constructed to prevent movement of the first member relative to the second member when the engaging section is in engagement with the engaged section. Further, preferably, the rotation mechanism (50) includes a shaft section (36) provided on any one of the first member and the second member and an insertion section (16) provided in the other of the first member and the second member for insertion therein of the shaft section, and pivoting movement, about the shaft section, the first member is prevented by the engaging section engaging the engaged section with the shaft section inserted in the insertion section.

By the provision of the positioning mechanism which positions the device using the dead weight of the device, the present invention allows positioning, about the shaft, of the first member and the device to be performed with ease and in safety. Thus, the present invention allows the orientation, in the rotational direction, of the device to be adjusted to any desired orientation with ease.

Further, preferably, any one of the engaging section (18) and the engaged section (38) of the positioning mechanism (40) is an externally toothed engagement member (18) having a plurality of outer surface teeth (18a) formed thereon along the periphery of the shaft section (36) or the insertion section (16), and the other of the engaging section and the engaged section of the positioning mechanism is an internally toothed engagement member (38) having a plurality of inner surface teeth (38a) formed thereon along the periphery of the insertion section or the shaft section. The externally toothed engagement member (18) is meshingly engageable with the internally toothed engagement member (38) in such a manner that a meshed position, about the shaft section (36), of the externally toothed engagement member relative to the internally toothed engagement member is switchable so as to change a rotational orientation, about the shaft section, of the externally toothed engagement member relative to the internally toothed engagement member.

When a rotational orientation, about the shaft section, of the devices is to be determined at the time of positioning of the device, the present invention allows the device to be positioned in a desired orientation with a high accuracy. Further, with the positioning mechanism comprising the externally toothed engagement member and the internally toothed engagement member meshingly engaging with each other along their radially outer and inner peripheral surfaces, the present invention can minimize the possibility of the meshing engagement between the externally and internally toothed engagement members in the positioning mechanism being accidentally canceled. Namely, because the shaft section is inserted in the insertion section, the first member and the second member are not movable relative to each other in the radial direction although the first member and the second member are movable relative to each other in the axial direction. Therefore, if there is employed a construction where the engaging section and the engaged section of the positioning mechanism engage with each other in the axial direction, the engagement between the engaging section and the engaged section may be accidentally canceled easily as the first member moves in the axial direction. By contrast, in the present where the engaging section and the engaged section mesh with each other along their radially outer and inner peripheral surfaces, i.e. mesh with each other in a direction perpendicular to the axial direction of the shaft section fittingly inserted in the insertion section, there is no possibility of the engagement between the engaging section and the engaged section being accidentally canceled. As a result, the present invention can effectively prevent positional deviation of the device after the positioning of the device.

Further, preferably, the shaft section (36) has, in a halfway position along the axial direction thereof; a narrowed portion (36b) having a smaller outer diameter than a remaining portion thereof, and, with the shaft section (36) inserted in the insertion section (16), the shaft section is prevented from coming out of the insertion section by a fastening member (13), mounted to the first member (10), engaging with a larger-diameter portion (36a) of the shaft section adjoining the narrowed portion (36a).

By the fastening member engaging with the larger-diameter portion of the shaft section adjoining the narrowed portion, the present invention can prevent the shaft section from accidentally coming out of the insertion section. In this way, the present invention can prevent the first and second members from being accidentally disassembled from each other, and thus, it can prevent the device, mounted on the mounting surface like a side wall via the inventive device mounting apparatus comprising the first and second members, from accidentally falling down from the mounting surface.

Further, preferably, by the fastening member (13) engaging with the larger-diameter portion (36a) of the shaft section (36) adjoining the narrowed portion (36b), cancellation of the engagement between the engaging section (18) and the engaged section (38) is permitted with the shaft section still maintained in a state capable of being prevented from coming out of the insertion section. As one implementation of such a construction, a range (L1) over which the fastening member (13) is movable within the narrowed portion (36b) in the axial direction of the shaft section (36) as the shaft section is moved axially in a direction to come out of the insertion section is set greater than a range (L2) over which the engaging section can be maintained in the engagement with the engaged section (L1>L2).

Thus, even when, for positioning the first member about the shaft section, the first member is moved relative to the second member in the axial direction to cancel the meshing engagement between the engaging and engaged section, the present invention can keep the shaft section in a state capable of being prevented from coming out of the insertion section, by the fastening member screw engaging with the narrowed portion and particularly with an end of the narrowed portion, more specifically the larger-diameter portion adjoining the narrowed portion. In this way, when the first member and the device are to be positioned relative to the second member, the present invention can avoid the risk or possibility of the first member and the second member from being accidentally disassembled from each other so that the first member and the device fall down from the mounting part.

The following will describe embodiments of the present invention, but it should be appreciated that the present invention is not limited to the described embodiments and various modifications of the invention are possible without departing from the basic principles. The scope of the present invention is therefore to be determined solely by the appended claims.

### BRIEF DESCRIPTION OF THE DRAWINGS

Certain preferred embodiments of the present invention will hereinafter be described in detail, by way of example only, with reference to the accompanying drawings, in which:

FIG. 1 is a perspective view of a speaker mounting apparatus according to a preferred embodiment of the present invention, which particularly shows a support member and a fixing plate in an assembled state;

FIG. 2 is a perspective view of the speaker mounting apparatus according to the preferred embodiment of the present invention, which particularly shows the support member and the fixing plate in a disassembled state;

FIG. 3 is a partly sectional side view of the speaker mounting apparatus;

FIGS. 4A and 4B are sectional side views showing a rotation mechanism and other elements around the rotation mechanism; and

FIGS. 5A and 5B are plan views showing the rotation mechanism and a positioning mechanism in the speaker mounting apparatus.

### DETAILED DESCRIPTION

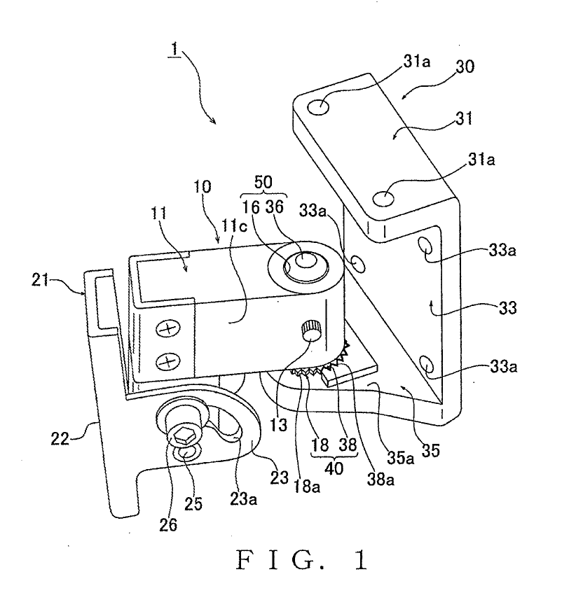

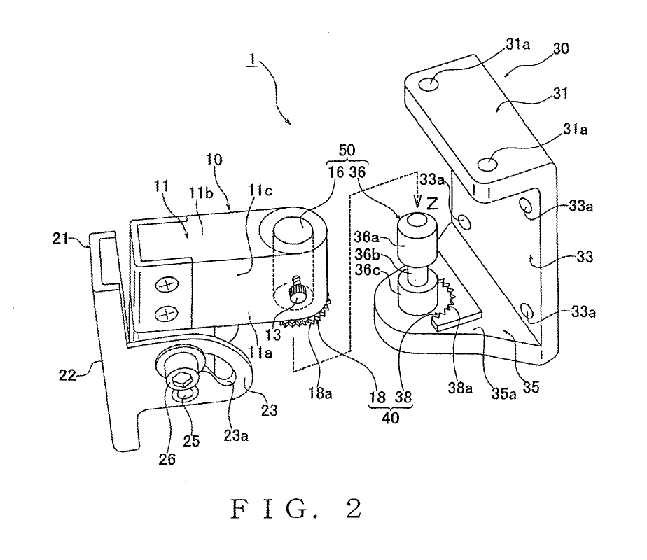

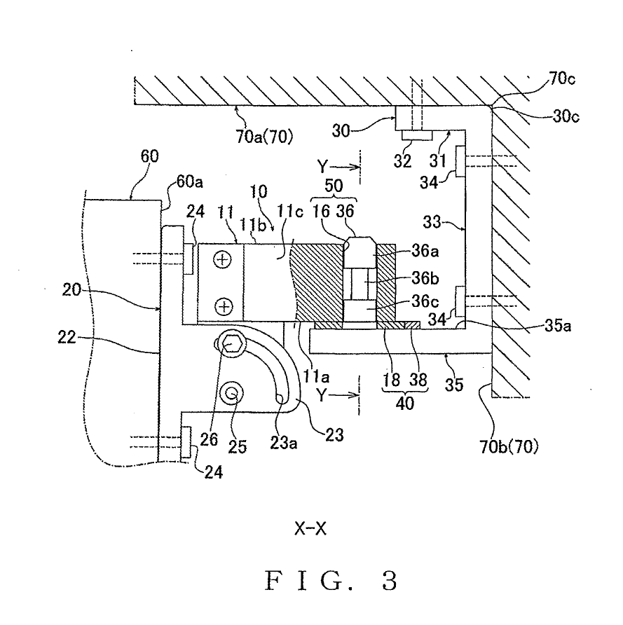

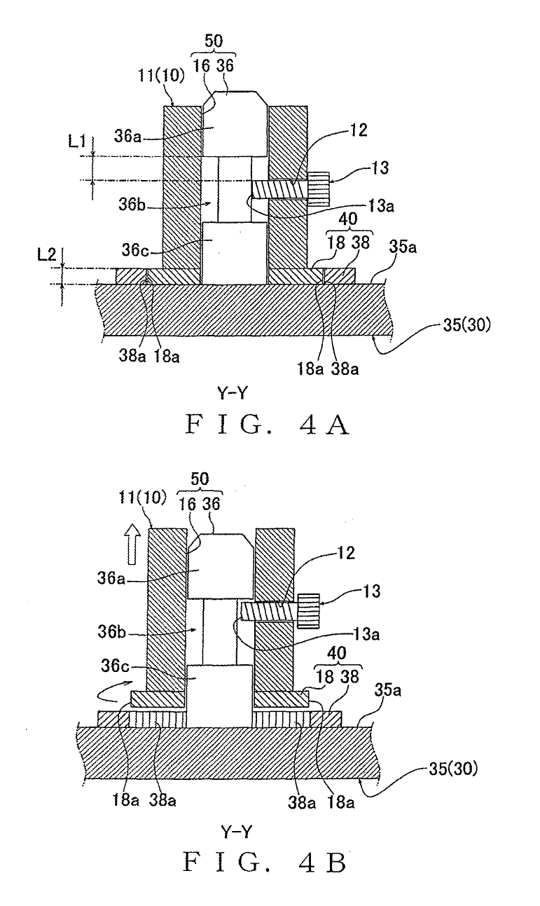

FIGS. 1 and 2 are perspective views showing a speaker mounting apparatus 1 according to a preferred embodiment of the present invention, of which FIG. 1 shows a later-described support member 10 and fixing plate 30 in an assembled state while FIG. 2 shows the support member 10 and fixing plate 30 in a disassembled state. Further, FIG. 3 is a partly sectional side view, taken along an X-X arrowed line of FIG. 4, showing the speaker mounting apparatus 1 with a speaker unit 60 mounted to a wall section 70. The speaker mounting apparatus 1 shown in these figures includes the support member 10 (i.e., a first member) adapted to be fixed to the speaker unit 60, and the fixing plate 30 (i.e., a second member) adapted to be fixed to a mounting surface (i.e., a mounting part) of the wall section 70, such as a ceiling 70a and side wall 70b of a room.

The fixing plate 30, which is a member formed by bending a metal plate into a generally U sectional shape, integrally has an upper plate section 31 extending in one direction, a side plate section 33 extending from one end of the upper plate section 31 in a direction perpendicular to the upper plate section 31, and a lower plate section 35 extending from one end, remote from the upper plate section 31, of the side plate section 33 in parallel to the upper plate section 31. The planes of the upper plate section 31 and the side plate section 33 make a right angle with each other, and the planes of the side plate section 33 and the lower plate section 35 make a right angle with each other. Further, the upper plate section 31 has bolt holes 31a formed therein for insertion therethrough of bolts 32 (FIG. 3) for fastening or fixing the fixing plate 30 to the ceiling 70a, and the side plate section 33 has bolt holes 33a formed therein for insertion therethrough of bolts 34 (FIG. 3) for fixing the fixing plate 30 to the side wall 70b. In the following description, terms “upper” and “lower” are used to refer to “upper” and “lower” in a state where the upper plate section 31 of the fixing plate 30 is fastened to the ceiling 70a, the side plate section 33 is fixed to the side wall 70b and also the fixing plate 30 and the support member 10 are interconnected.

Further, the lower plate section 35 of the fixing plate 30 has, on its upper surface 35a (i.e., a supporting surface), a shaft section 36 of a cylindrical columnar bar shape extending vertically upward toward the upper plate section 31 in parallel to the plane of the side plate section 33. The shaft section 36 has generally the same height dimension as a later-described base section 11 of the support member 10. Further, the shaft section 36 has, in a halfway position along an axial (vertical) direction thereof, a narrowed portion 36b (i.e., a reduced-diameter portion) having a smaller outer diameter than the remaining portions thereof. Namely, the narrowed portion 36b is provided between an upper portion 36a and a lower portion 36c and has a smaller outer diameter than the upper portion 36a and lower portion 36c. The upper portion 36a and lower portion 36c will be referred to also as “upper and lower larger-diameter portions”.

An internally toothed engagement member 38 (i.e., an engaged section) having a plurality of teeth 38a (i.e., inner surface teeth) formed in the radially inner peripheral surface thereof is provided around the outer circumference of the shaft section 36 on the upper surface 35a of the lower plate section 35 of the fixing plate 30. The internally toothed engagement member 38 is a thin plate-shaped member concentric with the shaft section 36 and having a semi-circular inner peripheral surface, and the inner surface teeth 38a are disposed around a part of the outer circumference or periphery of the shaft section 36.

The support member 10 includes the base section 11 engageable with (operatively connectable with) the fixing plate 30, and a speaker mounting plate 21 connected to the base section 11 in such a manner that it is pivotable via a pivot shaft 25. The base section 11 has a generally L shape as viewed in side elevation, and an insertion hole 16 (i.e., an insertion portion) for pivotably inserting therethrough the shaft section 36 of the fixing plate 30 is formed in a distal end portion of the base section 11. The insertion hole 16 is a through-hole of a cylindrical shape extending through the base section 16 from the upper surface 10b to the lower surface 10a of the base section 11. The insertion hole 16 of the support member 10 has an inner diameter slightly greater than the outer diameter of the shaft section 36 (more specifically, outer diameter of the upper and lower larger-diameter portions 36a and 36c), so that the shaft section 36 is pivotably inserted fittingly in the insertion hole 16. The insertion hole 16 and the shaft section 36 together constitute a rotation mechanism 50 supporting the support member 10 in such a manner that the support mechanism 10 is horizontally pivotable relative to the fixing plate 30. FIGS. 4A and 4B are sectional side views, taken along a Y-Y arrowed line of FIG. 3, showing the rotation mechanism 50 and other elements around the rotation mechanism 50.

Further, a pair of plate-shaped flange portions 23 formed on opposite sides of a mounting surface 22 of the speaker mounting plate 21 are mounted to opposite side surfaces 11c of the base section 11 near the proximal end of the base section 11. The flange portions 23 are pivotably mounted to the base section 11 via a horizontal pivot shaft 25. Note that each of the figures in the accompanying drawings shows only one of the flange portions 23. A through-hole 23a of a generally arch shape is formed in the flange portion 23 along a part of the outer periphery of the pivot shaft 25. A fastening screw 26 inserted through the through-hole 23a is mounted to the side surface 11c of the base section 11. As the flange portion 23 and through-hole 23a are moved relative to the fastening screw 26 after the fastening screw 26 is loosened, the speaker mounting plate 21 pivots vertically (in an up-down direction) about the pivot shaft 25. Then, as the fastening screw 26 is tightened with the mounting surface 22 of the speaker mounting plate 21 set at a desired angle (vertical orientation), the angle (vertical orientation) of the speaker mounting plate 21 relative to the base section 11 is fixed.

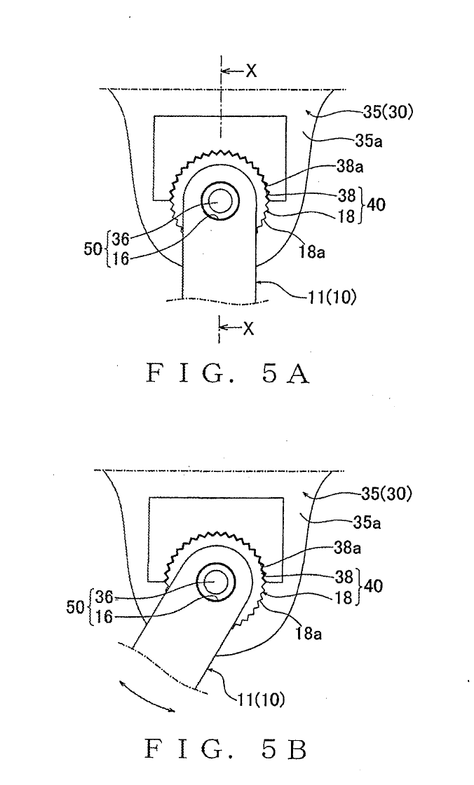

Further, an externally toothed engagement member 18 (i.e., an engaging section) having a plurality of teeth 18a (i.e., outer surface teeth) formed on the radially outer peripheral surface thereof are provided on the lower surface 11a of the base section 11 around the outer periphery of the insertion hole 16. The externally toothed engagement member 18, which is a thin plate-shaped member of a circular annular shape, is fixed to the lower surface 11a of the base section 11 with its teeth 18a projecting outwardly slightly beyond the side surface 11c of the base section 11, so that the outer surface teeth 18a of the externally toothed engagement member 18 are engageable with the inner surface teeth 38a of the internally toothed engagement member 38 provided on the fixing plate 30. The externally toothed engagement member 18 and the internally toothed engagement member 38 together constitute a positioning mechanism 40 for positioning a position of the support member 10 in the rotational direction (rotational position or orientation) about the shaft section 36 relative to the fixing plate 10. FIGS. 5A and 5B show the above-mentioned positioning mechanism 40 and rotation mechanism 50 with a later-described fastening screw 13 omitted for clarity.

Further, the fastening screw 13 (i.e., a fastening member), which is mounted to the side surface 11c of the base section 11 of the support member 10, is inserted through the thickness of the base section 11 into the insertion hole 16. More specifically, with the fastening screw 13 fully screwed into a screw hole (see FIGS. 4A and 4B) formed in the side surface 11c of the base section 11, the distal end 13a projects into the insertion hole 16. The distal end 13a of the screwing screw 13 projecting into the insertion hole 16 is located in and abuttingly engages with the narrowed portion 36b of the shaft section 36. Further, as shown in FIG. 4A, a range (distance) L1 over which the fastening screw 13 is relatively movable upward within the narrowed portion 36b is set greater than a range (or distance) L2 over which the externally toothed engagement member 18 and the internally toothed engagement member 38 can be maintained in engagement with each other (i.e., greater than the thickness of each of the externally toothed engagement member 18 and internally toothed engagement member 38) (L1>L2). Further, the narrowed portion 36b has a depth set such that the engagement between the fastening screw 13 and the narrowed portion 36b is not canceled, i.e. the screwing screw 13 does not get out of the narrowed portion 36b, even when the screwing screw 13 abuttingly engaging with the shaft section 36 is slightly loosened.

The following describe an operational sequence for mounting, via the speaker mounting apparatus 1 constructed in the aforementioned manner, the speaker unit 60 to a corner portion 70c between the ceiling 70a and the side wall 70b of the room. For this purpose, the fixing plate 30 is fixed or fastened to the ceiling 70a and side wall 70b by means of the bolts 32 and 34 of FIG. 3 with the support member 10 and the fixing plate 30 disassembled from each other as shown in FIG. 2. At that time, a corner portion 30c where the upper plate section 31 and the side wall section 33 of the fixing plate 30 meet each other is superposed on the corner portion 70c between the ceiling 70a and the side wall 70b, in which state the upper plate section 31 is fixed to the ceiling 70b while the side plate section 33 is fixed to the side wall 70b. Thus, the fixing plate 30 is fixed to the ceiling 70a and the side wall 70b, and the lower plate section 35 of the fixing plate 30 projects laterally (horizontally) beyond the side wall 70b beneath the ceiling 70a.

Also, the speaker unit 60 is fixed to the support member 10. For this purpose, the speaker unit 60 is fastened at its back surface 60a to the mounting surface 22 of the speaker unit 60 by means of bolts 24. Thus, the speaker unit 60 and the speaker unit 60 are integrally fixed together. It is preferable that the operation for fixing the speaker unit 60 to the mounting surface 22 be performed after the fastening screw 26 is loosened to adjust as desired the angle of the mounting surface 22 relative to the base section 11, with a view to facilitating the fastening by the bolts 24 can be facilitated.

Then, the insertion hole 16 of the support member 10 is put over the shaft section 36 of the fixing plate 30 as indicated by a broken-line arrow Z in FIG. 2, so that the shaft section 36 is fittingly inserted into the insertion hole 16 from beneath the insertion hole 16. In this state, a human operator gradually lowers the height position of the support member 10 relative to the fixing plate 30, using the dead weights of the support member 10 and speaker unit 60, while supporting the support member 10 and speaker unit 60. Finally, the support member 10 is mounted integrally to the fixing plate 30 with the base section 11 of the support member 10 placed on the lower plate section 35 of the fixing plate 30 (more specifically, with the externally toothed engagement member 18 placed on the lower plate section 35).

At that time, the outer surface teeth of the externally toothed engagement member 18 provided on the support member 10 and the inner surface teeth of the internally toothed engagement member 38 provided on the fixing plate 30 meshingly engage with each other. Thus, pivoting movement of the support member 10 about the shaft section 36 is prevented, so that the support member 10 is positioned in the peripheral or rotational direction relative to the fixing plate 30. Then, because the externally toothed engagement member 18 and the internally toothed engagement member 38 each have a plurality of teeth (outer surface teeth 18a or inner surface teeth 38a), the externally toothed engagement member 18 and the internally toothed engagement member 38 are meshingly engageable with each other at a plurality of different positions along the rotational direction, as shown in FIGS. 5A and 5B. More specifically, the plurality of outer surface teeth 18a of the externally toothed engagement member 18 and the plurality of inner surface teeth 38a of the internally toothed engagement member 38 are meshingly engageable with each other at any one of a plurality of different positions (angles) along the rotational direction in such a manner that the meshed position of the externally toothed engagement member 18 relative to the internally toothed engagement member 38 is switchable to any desired one of different meshed positions about the shaft section 36, i.e. that a rotational position (or orientation), about the shaft section 36, of the externally toothed engagement member 18 relative to the internally toothed engagement member 38 is changed as required. In other words, in the instant embodiment, a relative rotational position between the externally toothed engagement member 18 and the internally toothed engagement member 38 can be determined in such a manner that the respective teeth 18a and 38a mesh with each other at a desired meshed position. In this case, the resolution with which the meshed position of the externally toothed engagement member 18 relative to the internally toothed engagement member 38 is switchable or adjustable is one tooth (one tooth pitch).

Thus, in order to adjust orientations, in the peripheral or rotational direction, of the support member 10 and speaker unit 60, the support member 10 is lifted slightly upward along the axis of the shaft section 36 until the externally toothed engagement member 18 is disengaged from the internally toothed engagement member 38 as shown in FIG. 4B, and then, the support member 10 is pivoted about the shaft section 36 to be oriented in a desired direction as shown in FIG. 5B. Then, in that position, the support member 10 is lowered so that the externally toothed engagement member 18 is engaged with the internally toothed engagement member 38 again. In this way, the support member 10 can be positioned at a desired orientation.

Then, with the externally toothed engagement member 18 and the internally toothed engagement member 38 meshingly engaging with each other, the fastening screw 13 is tightened to cause the distal end 13a of the fastening screw 13 to abuttingly engage with the narrowed portion 36b as shown in FIG. 4A. In the aforementioned manner, the shaft section 36 can be prevented from accidentally coming out of the insertion hole 16, so that the support member 10 can be prevented from being accidentally detached from the fixing plate 30. In this way, the instant embodiment can prevent the fixing plate 30 and the support member 10 from being accidentally disassembled from each other, and thus, it can prevent the speaker unit 60, mounted on the wall section 70, from accidentally falling down from the wall section 70.

As shown in FIG. 4A, the range (distance) L1 over which the insertion hole 16 (support member 10) is movable upward in the axial direction of the shaft section 36 with the fastening screw 13 held in engagement with the narrowed portion 36b is set greater than the range L2 over which the externally toothed engagement member 18 can be maintained in meshing engagement with the internally toothed engagement member 38 (i.e., greater than the thickness of each of the externally toothed engagement member 18 and internally toothed engagement member 38) (L1>L2). Thus, even when, for positioning the support member 10 about the shaft section 36, the support member 10 is moved upward in the axial direction to cancel the meshing engagement between the externally toothed engagement member 18 and the internally toothed engagement member 38, the instant embodiment can keep the shaft section 36 prevented from coming out of the insertion hole 16, by the screw 13 engaging with the narrowed portion 36b and particularly with the upper end of the narrowed portion 36b, more specifically the lower surface of the upper larger-diameter portion 36a. In this way, positioning of the support member 10 in the rotational direction thereof can be performed with the support member 10 reliably kept prevented from being detached from the fixing plate 30. Thus, when the support member 10 and the speaker unit 60 are to be positioned relative to the fixing plate 30, the instant embodiment can avoid the possibility of the support member 10 and the fixing plate 30 being accidentally disassembled from each other so that the support member 10 and the speaker unit 60 fall down from the wall section 70.

As set forth above, the preferred embodiment of the speaker mounting apparatus 1 includes: the support member 10 adapted to be fixed to the speaker unit 60; the fixing plate 30 adapted to be fixed to the wall section 70; and the positioning mechanism 40 including the externally toothed engagement member 18 (i.e., the engaging section) provided on the support member 10 and the internally toothed engagement member 38 (i.e., the engaged section) provided on the fixing plate 30. By the externally toothed engagement member 18 of the positioning mechanism 40 being brought into meshing engagement with the internally toothed engagement member 38 by the dead weights of the support member 10 and speaker unit 60, pivoting movement of the support member 10 relative to the fixing plate 30 is prevented, so that the support member 10 is positioned in its rotational direction relative to the fixing plate 30.

By the provision of the positioning mechanism 40 where the externally toothed engagement member 18 is brought into meshing engagement with the internally toothed engagement member 38 by the dead weights of the support member 10 or the speaker unit 60 fixed to the support member 10, the instant embodiment of the speaker mounting apparatus 1 allows the human operator to appropriately position the speaker unit 60 by merely engaging the externally toothed engagement member 18 with the internally toothed engagement member 38 using the dead weight of the speaker unit 60. Thus, the human operator can perform, with ease and in safety, the speaker unit positioning operation in safety when the speaker unit 60 is to be mounted to the wall section 70, such as the ceiling 70a or side wall 70b, or positioning adjustment operation after the mounting to the wall section 70 of the speaker unit 60.

The instant embodiment of the speaker mounting apparatus 1 also includes the rotation mechanism 50 for rotatably supporting, by means of the shaft section 36 provided on the fixing plate 30 and the insertion hole 16 provided in the support member 10, the support member 10 in such a manner that the support member 10 is rotatable relative to the fixing plate 30. By the externally toothed engagement member 18 meshingly engaging with the internally toothed engagement member 38 with the shaft section 36 inserted in the insertion hole 16, the support member 10 is prevented from pivoting about the shaft section 36.

By the provision of the positioning mechanism 40 which positions the speaker unit 60 using the dead weight of the speaker unit 60, the instant embodiment of the speaker mounting apparatus 1 allows positioning, about the shaft section 36 (in the rotational direction), of the support member 10 and the speaker unit 60 to be performed with ease and in safety. Thus, the instant embodiment of the speaker mounting apparatus 1 allows the orientation, in the rotational direction, of the speaker unit 60 to be adjusted to any desired orientation with ease.

Further, in the instant embodiment of the speaker mounting apparatus 1, the positioning mechanism 40 includes the externally toothed engagement member 18 having the plurality of outer surface teeth 18a formed on its outer peripheral surface along the insertion hole 16, and the internally toothed engagement member 38 having the plurality of inner surface teeth 38a formed on its inner peripheral surface along the shaft section 36, and the externally toothed engagement member 18 is meshingly engageable with the internally toothed engagement member 38 in such a manner that the meshed position thereof relative to the internally toothed engagement member 38 is adjustable to any desired one of different meshed positions about the shaft section 36, i.e. that the rotational position (orientation), about the shaft section 36, of the externally toothed engagement member 18 relative to the internally toothed engagement member 38 is adjustable as desired.

Thus, when a rotational orientation, about the shaft section 36, of the speaker unit 60 is to be determined at the time of positioning of the speaker unit 60, the instant embodiment of the speaker mounting apparatus 1 allows the speaker unit 60 to be positioned in a desired orientation with a high accuracy. Further, with the positioning mechanism 40 comprising the externally toothed engagement member 18 and the internally toothed engagement member 38 meshingly engaging with each other along their radially outer and inner peripheral surfaces, the instant embodiment of the speaker mounting apparatus 1 can minimize the possibility of the meshing engagement between the toothed engagement members 18 and 38 in the positioning mechanism 40 being accidentally canceled. Namely, because the shaft section 36 is inserted in the insertion hole 16, the support member 10 and the fixing plate 30 are not movable relative to each other in the radial direction although the support member 10 and the fixing plate 30 are movable relative to each other in an axial direction (rotation axis direction) of the support member 10. Therefore, if there is employed a construction where the engaging section and the engaged section of the positioning mechanism 40 engage with each other in the axial direction, the engagement between the engaging section and the engaged section may be accidentally canceled easily as the support member 10 moves in the axial direction. By contrast, in the instant embodiment of the speaker mounting apparatus 1 where the externally toothed engagement member (engaging section) 18 and the internally toothed engagement member (engaged section) 38 mesh with each other along their radially outer and inner peripheral surfaces, i.e. mesh with each other in a direction perpendicular to the axial direction of the shaft section 36 fittingly inserted in the insertion hole 16, there is no possibility of the engagement between the engaging section and the engaged section being accidentally canceled. As a result, the instant embodiment can effectively prevent positional deviation of the speaker unit 60 after the positioning of the speaker unit 60.

Further, in the instant embodiment of the speaker mounting apparatus 1, the shaft section 36 has, in its halfway position along the axial direction, the narrowed portion 36b having a smaller outer diameter than the remaining portions thereof. Thus, by the fastening screw 13 mounted on the support member 10 being engaged with the narrowed portion 36b with the shaft section 36 inserted in the insertion hole 16, the shaft section 36 can be prevented from accidentally coming out of the insertion hole 16.

By the fastening screw 13 being engaged with the narrowed portion 36b, the shaft section 36 of the fixing plate 30 can be prevented from accidentally coming out of the insertion hole 16 of the support member 10. Thus, with the shaft section 36 inserted in the insertion hole 16, the instant embodiment can prevent the fixing plate 30 and the support member 10 from being accidentally disassembled from each other, and thus, it can reliably prevent the speaker unit 60, mounted on the wall section 70, from accidentally falling down from the wall section 70.

It should be appreciated that the present invention is not limited to the above-described preferred embodiment and can be modified variously within the scope of appended claims and within the scope of the technical idea disclosed in the specification and drawings. For example, whereas the speaker mounting apparatus 1 has been described above as an example of the device mounting apparatus of the present invention, the device mounting apparatus of the present invention may be implemented as other than the speaker mounting apparatus 1, such as apparatus for mounting various devices like a display device, monitoring camera and illuminating device.

Furthermore, the engaging section and the engaged section constituting the positioning mechanism 40 in the present invention are not limited to externally and internally toothed engagement members each having a plurality of teeth (inner surface teeth 18a or outer surface teeth 38a) and may be replaced with an engagement mechanism including, for example, an engaging recess and an engaging projection that engage with each other only at one point.

Furthermore, the preferred embodiment of the speaker unit 1 has been described above in relation to the case where the externally toothed engagement member 18 is provided on the support member 10 and the internally toothed engagement member 38 is provided on the fixing plate 30. Conversely to the above, the externally toothed engagement member 18 may be provided on the fixing plate 30 and the internally toothed engagement member 38 may be provided on the support member 10, although not shown.

Furthermore, whereas the preferred embodiment of the speaker unit 1 has been described above in relation to the case where the shaft section 36 provided on the fixing plate 30 and the insertion hole 18 provided in the support member 10 constitute the rotation mechanism 50 for rotatably supporting the support member 10 relative to the fixing plate 30, the shaft section 36 of the rotation mechanism may be provided on the support member 10 and the insertion hole (insertion section) 16 may be provided in the fixing plate 30.

Furthermore, the shape of the fixing plate 30 shown in relation to the preferred embodiment is merely illustrative, and the fixing plate 30 to be fixed to the mounting surface of the wall section 70 or the like may be of any other desired shape. For example, the fixing plate 30 may be shaped to have only the side plate section 33 and lower plate section 35 with the upper plate section 31 omitted. Note that, in the case where the fixing plate 30 has the upper plate section 31, sizing and shaping has to be employed such that the base section 11 of the support member 10 does not interfere with the upper plate section 31 of the fixing plate 30 when the fixing plate 30 and the support member 10 are to be interconnected with the insertion hole 16 of the support member 10 passed over the shaft section 36 of the fixing plate 30.

This application is based on, and claims priority to, Japanese Patent Application No. 2012-132775 filed on 12 Jun. 2012. The disclosure of the priority application, in its entirety, including the drawings, claims, and the specification thereof, are incorporated herein by reference.

What is claimed is:

1. A device mounting apparatus for mounting a device to a mounting part, comprising:
a first member adapted to be fixed to the device;
a second member adapted to be fixed to the mounting part; and
a positioning mechanism including an engaging section provided on said first member and an engaged section provided on said second member and engageable with said engaging section, said positioning mechanism being constructed in such a manner that said engaging section is brought into engagement with said engaged section by dead weights of said first member and the device,
wherein, by said engaging section engaging with said engaged section, movement of said first member relative to said second member is prevented so that said first member is positioned relative to said second member.

2. The device mounting apparatus as claimed in claim 1, which further comprises a rotation mechanism for rotatably supporting said first member relative to said second member, and
said positioning mechanism is constructed to prevent movement of said first member relative to said second member when said engaging section is in engagement with said engaged section.

3. The device mounting apparatus as claimed in claim 2, wherein said rotation mechanism includes a shaft section provided on any one of said first member and said second member, and an insertion section provided in other of said first member and said second member for insertion therein of said shaft section, and
wherein pivoting movement, about said shaft section, said first member is prevented by said engaging section engaging said engaged section with said shaft section inserted in said insertion section.

4. The device mounting apparatus as claimed in claim 3, wherein any one of said engaging section and said engaged section of said positioning mechanism is an externally toothed engagement member having a plurality of outer surface teeth formed thereon along a periphery of said shaft section or said insertion section, and other of said engaging section and said engaged section of said positioning mechanism is an internally toothed engagement member having a plurality of inner surface teeth formed thereon along the periphery of said insertion section or said shaft section, and
wherein the externally toothed engagement member is meshingly engageable with the internally toothed engagement member in such a manner that a meshed position, about said shaft section, of the externally toothed engagement member relative to the internally toothed engagement member is switchable so as to change a rotational orientation, about said shaft section, of the externally toothed engagement member relative to the internally toothed engagement member.

5. The device mounting apparatus as claimed in claim 3, wherein said shaft section has, in a halfway position along an axial direction thereof, a narrowed portion having a smaller outer diameter than a remaining portion thereof, and
wherein, with said shaft section inserted in said insertion section, said shaft section is prevented from coming out of said insertion section by a fastening member, mounted to said first member, engaging with a larger-diameter portion of said shaft section adjoining the narrowed portion.

6. The device mounting apparatus as claimed in claim 5, wherein, by the fastening member engaging with the larger-diameter portion of said shaft section adjoining the narrowed portion, cancellation of the engagement between said engaging section and said engaged section is permitted with said shaft section still maintained in a state capable of being prevented from coming out of said insertion section.

7. The device mounting apparatus as claimed in claim 6, wherein a range over which the fastening member is movable within the narrowed portion in the axial direction of said shaft section as said shaft section is moved axially in a direction to come out of said insertion section is set greater than a range over which said engaging section can be maintained in the engagement with said engaged section.

8. The device mounting apparatus as claimed in claim 1, wherein said engaged section of said positioning mechanism is provided on a supporting surface provided on said second member, and said positioning mechanism is constructed in such a manner that said engaging section is brought into the engagement with said engaged section while said first member is supported on the supporting surface.

9. The device mounting apparatus as claimed in claim 1, wherein said positioning mechanism is constructed to prevent lateral and downward movement of said first member relative to said second member.

10. The device mounting apparatus as claimed in claim 1, which further comprises a screw for, when said first member has been positioned relative to said second member by said positioning mechanism, keeping said first member positioned relative to said second member.

11. The device mounting apparatus as claimed in claim 1, which further comprises a mechanism for guiding said first member to a position where said engaging section is brought into the engagement with said engaged section.

12. The device mounting apparatus as claimed in claim 1, wherein the device is a speaker unit.
